(19) United States
(12) Patent Application Publication
(10) Pub. No.: US 2023/0256459 A1
(43) Pub. Date: Aug. 17, 2023

(54) ASPIRATING SPRAY NOZZLE ASSEMBLY

(71) Applicant: Spray Nozzle Engineering Pty Ltd, Mentone (AU)

(72) Inventor: Sean MORGAN, Mentone (AU)

(21) Appl. No.: 17/721,162

(22) Filed: Apr. 14, 2022

(30) Foreign Application Priority Data
Feb. 17, 2022 (AU) 2022201073

(51) Int. Cl. B05B 1/34

(52) U.S. Cl. CPC B05B 1/34; B05B 1/341

(57) ABSTRACT

An aspirating spray nozzle assembly includes a nozzle body and a distributor removably attached to one another. The nozzle body includes a first inlet, a first chamber, an orifice disc and an annular catchment. The first inlet has a first end and a second end. The first chamber facilitates diffusion of the liquid jet. The first chamber has a third end in communication with the second end of the first inlet and a fourth end in communication with the distributor. The orifice disc is received within the first inlet. The orifice disc has a dispersing means adapted to cause the liquid jet to spread. The annular catchment encircles the fourth end of the first chamber. The annular catchment is configured to catch and deflect a portion of liquid splashback by the interfering means such that the portion of deflected liquid splashback is redirected downstream into the distributor.

### TECHNICAL FIELD

The present invention relates to an aspirating spray nozzle assembly. More particularly, the present invention relates to a compact aspirating spray nozzle assembly capable of generating a short range conical spray plume.

### BACKGROUND OF THE INVENTION

In conventional foam spray nozzle assemblies and general applications, the foam distribution needs to be extremely narrow for a requirement of maximum trajectory distance, velocity & volume. The extremely narrow pattern typical of prior art devices is created via a long venturi tube type arrangement such as that disclosed in U.S. Pat. No. 5113945 among other prior art, where it is apparent that no obstacle or interference to the internal liquid jet exists within the venturi tubes. In order to create a solid liquid jet, these conventional spray nozzles commonly referred to as ‘injector nozzles’ involve the use of a swirl chamber at inlet followed by a long tapering passage. These nozzles have a shortcoming of being relatively long, typically twice to three times the length of a standard full cone nozzle with an included angle of 50 degrees to 120 degrees included angle. There are also some spray nozzle assemblies available in the marketplace that have minimal interference and obstacles within the venturi foam nozzle so as to keep the resistance to flow and aspiration to a bare minimum in order to achieve maximum trajectory and foam efficiency. There is however a need for mining vehicles for example to have spray nozzle assemblies which are able to effect wide dispersion over a very short distance for fire protection purposes.

In light of the above, internal swirling chamber inserts or dispersing baffles are normally found to exist in ‘non-aspirating’ nozzles to produce a wide full cone dispersion. Although such swirling inserts or dispersing baffles are essential and thus included within a typical nozzle chamber to produce wide full dispersions, if applied for the purpose of foam dispersion as described above, they are found to be major impediments and obstacles towards the very functionality of ‘aspirating’ nozzles, due to the interference placed upon the aspiration functionality. The existing aspirating spray nozzles are have the shortcomings of being extremely long with major limitations for installation in close quarter applications and generating a limited spray spread which is grossly inadequate.

Previous attempts have been made to produce a foaming nozzle for wide, short trajectory dispersions to overcome the above shortcomings. Such a nozzle is designed to aspirate atmospheric air for Foaming purposes and uniquely draw air via the creation of a negative pressure zone at the exit end_via the projection of a liquid plume. The negative pressure zone would only function properly with an appropriately arranged and designed shield geometry. This type of nozzle also delivers the required benefits of compactness, robustness, serviceability, foam generating efficacy and functionality. Instead of using a swirl chamber and swirl device, this type of nozzle seeks to direct surrounding air about the outside of the liquid spray nozzle and its emissions, thus aerating said emissions externally to the nozzle at the apex of the emitted spray plume. This is achieved by means of a specially devised surrounding air shield which is complementary to the nozzle exterior. However, foaming performance limitations and problems continue to exist, mainly due to external air introduction at a negative pressure zone of the liquid plume projection apex, which introduce limitations in relation to the physical characteristics required of the nozzle. This type of nozzle also has another shortcoming in that its foaming performance is limited by the continued changes in formulation of foaming agents as a result of increased governing regulations surrounding the chemistry of the foaming agents.

In light of the above, the inclusion of a swirl chamber and a swirl device is still considered to be important and effective in facilitating distribution of the liquid and resultant foam in a wide conical pattern. The fact that the swirl chamber and swirl device being major impediments to aspiration and foaming performance however remains to be a problem.

Additionally, a standard swirl with normal vanes is commonly provided in the swirl chamber. The swirl is typically bent formed from a flat laser cut sheet metal. In its standard conventional form, such a swirl would produce a substantially hollow cone pattern. This is however a need to deliver more liquid centrally to the cone pattern.

Furthermore, in fulfilling the above requirements, a number of other features would need to be maintained to protect the nozzle function from blockage due to dirt, grease and grime before discharging in typically very difficult and harsh environments such as the engine bays of mining vehicles. Releasable or blow off caps have been devised to protect an exit orifice, such caps being released from the nozzle at liquid discharge. However, there is also a need to protect air aspiration holes from contaminant build-ups.

It is an object of the present invention to provide an aspirating nozzle assembly which may overcome or at least ameliorate the above shortcomings and/or problems, which may meet the above needs or which will at least provide a useful alternative.

### SUMMARY OF THE INVENTION

According to one aspect of the present invention, there is provided an aspirating spray nozzle assembly including a nozzle body and a distributor which are removably attached to one another; the nozzle body including:
a first inlet having a first end adapted to facilitate supply of a liquid jet and a second end;
a first chamber adapted to facilitate diffusion of the liquid jet and generation of a venturi effect, the first chamber having a third end being in communication with the second end of the first inlet and a fourth end being in directly or indirect communication with the distributor which includes a means adapted to interfere with the liquid jet;
one or more orifice disc(s) received within the first inlet being at or in close proximity to a second end, each of the one or more orifice disc(s) having one or more dispersing means adapted to cause the liquid jet to spread in the form of a cone having a defined angle; and
an annular catchment adapted to encircle the fourth end of the first chamber;
wherein the annular catchment is configured and disposed so as to catch and deflect at least a portion of any liquid splashback sent upstream by the interfering means such that the portion of deflected liquid splashback is redirected downstream again into the distributor.

The angle of spread of the turbulent jet may be dictated and varied by one or more of the following: the configuration of the dispersing means, the number of the dispersing means, the number of orifice discs and the combination of orifice discs. Preferably, the liquid jet included angle may vary between the range of 15° to 30°.

Preferably, a plurality of orifice discs is used to form a jet stream turbulator. The orifice discs may be combined, grouped and/or stepped. More preferably, the one or more dispersing means may include one or more openings provided in different geometric designs, patterns and/or configurations. In a preferred embodiment, an orifice disc with a forwardly flaring opening is splined with another orifice disc with a star-shaped polygonal opening so as to add turbulence to an already spread liquid jet. Additionally, each of the one or more openings includes an internal tapered thread or the like so as to generate a rifling effect thereby enhancing the turbulence. An orifice disc with such an opening may be a laser cut sandwich disc.

Preferably, the annular catchment is in the form of a groove. More preferably, the groove includes a profile which may be curved or take other shapes.

Conveniently, the nozzle body also includes a second chamber adapted to collect and contain the liquid splashback sent upstream by the interfering means.

Preferably, the distributor includes a vortex distributor which includes a swirl or a baffled distributor which includes dispersion baffles.

In a preferred embodiment, the swirl is formed with an oblong-shaped blank with rounded ends and a cut-out. More preferably, the cut-out is V-shaped flanked by two wings. The cut-out slot is located on the downstream side. Alternatively, the blank includes a rectangular slot. In an alternative embodiment, the blank has two cut-outs.

### BRIEF DESCRIPTION OF THE DRAWINGS

The invention may be better understood from the following non-limiting description of preferred embodiments, in which:

FIG. 1 is a perspective view of an aspirating spray nozzle assembly in accordance with a preferred embodiment of the present invention, the assembly including a protection sheath;

FIG. 2 is an exploded view of the aspirating spray nozzle assembly of FIG. 1 with a vortex distributor and the sheath in a detached state;

FIG. 3 is a cross sectional view of the aspirating spray nozzle assembly of FIG. 2;

FIG. 4 is a perspective cross sectional view of the aspirating spray nozzle assembly of FIG. 2;

FIG. 5 is a perspective view showing a cross section of the nozzle body with different versions of orifice discs;

FIG. 6 is a perspective exploded view illustrating the nozzle body together with a series of different orifice discs;

FIG. 7 is a schematic cross sectional view of showing the nozzle body and orifice discs of FIG. 6 after installation;

FIG. 8 is a perspective view of another preferred embodiment of the aspirating spray nozzle assembly with a baffled distributor;

FIG. 9 is a perspective cross sectional view of the aspirating spray nozzle assembly of FIG. 8;

FIG. 10 is a cross sectional view of the aspirating spray nozzle assembly of FIG. 9;

FIGS. 11A and B are plan and perspective views of one embodiment of a blank for forming a swirl, the blank having a V-shaped slot provided in the vortex distributor;

FIGS. 12A and B are plan and perspective views of another embodiment of the blank of FIGS. 11A and B with a rectangular slot;

FIG. 13 is a perspective view illustrating a preferred embodiment of a swirl formed by the blank of FIGS. 11A and B and incorporated into the nozzle assembly of FIG. 1;

FIG. 14A is a plan view of a further embodiment of a blank for forming a swirl;

FIGS. 14B and C are end and perspective views of a swirl formed by the blank of FIG. 14A;

FIG. 14D is a perspective view illustrating the swirl of FIG. 14C being incorporated into the nozzle assembly of FIG. 1;

FIG. 15A is a plan view of a further embodiment of a blank for forming a swirl;

FIGS. 15B and C are end and perspective views of a swirl formed by the blank of FIG. 15A;

FIG. 15D is a perspective view illustrating the swirl of FIG. 15C being incorporated into the nozzle assembly of FIG. 1;

FIG. 16A is a plan view of a further embodiment of a blank for forming a swirl;

FIGS. 16B and C are end and perspective views of a swirl formed by the blank of FIG. 16A;

FIG. 16D is a perspective view illustrating the swirl of FIG. 16C being incorporated into the nozzle assembly of FIG. 1;

FIG. 17A is a plan view of a further embodiment of a blank for forming a swirl;

FIGS. 17B and C are end and perspective views of a swirl formed by the blank of FIG. 17A;

FIG. 17D is a perspective view illustrating the swirl of FIG. 17C being incorporated into the nozzle assembly of FIG. 1;

FIG. 18A is a plan view of a further embodiment of a blank for forming a swirl;

FIGS. 18B and C are end and perspective views of a swirl formed by the blank of FIG. 18A;

FIG. 18D is a perspective view illustrating the swirl of FIG. 18C being incorporated into the nozzle assembly of FIG. 1;

FIG. 19A is a plan view of a further embodiment of a blank for forming a swirl;

FIGS. 19B and C are end and perspective views of a swirl formed by the blank of FIG. 19A; and

FIG. 19D is a perspective view illustrating the swirl of FIG. 19C being incorporated into the nozzle assembly of FIG. 1;

### DETAILED DESCRIPTION OF THE DRAWINGS

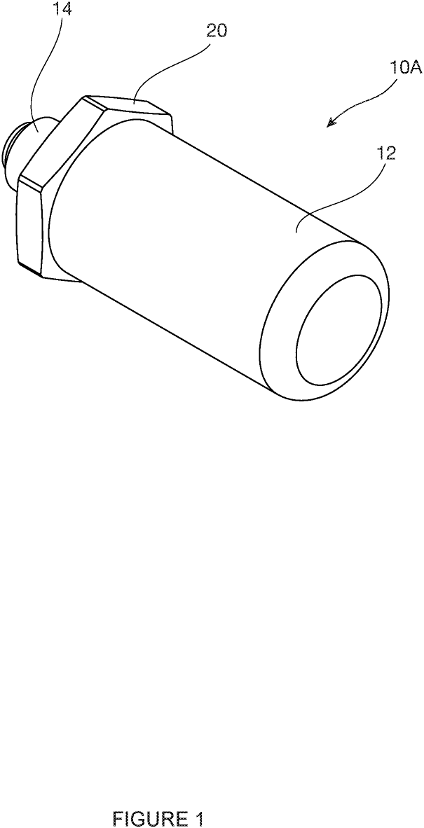

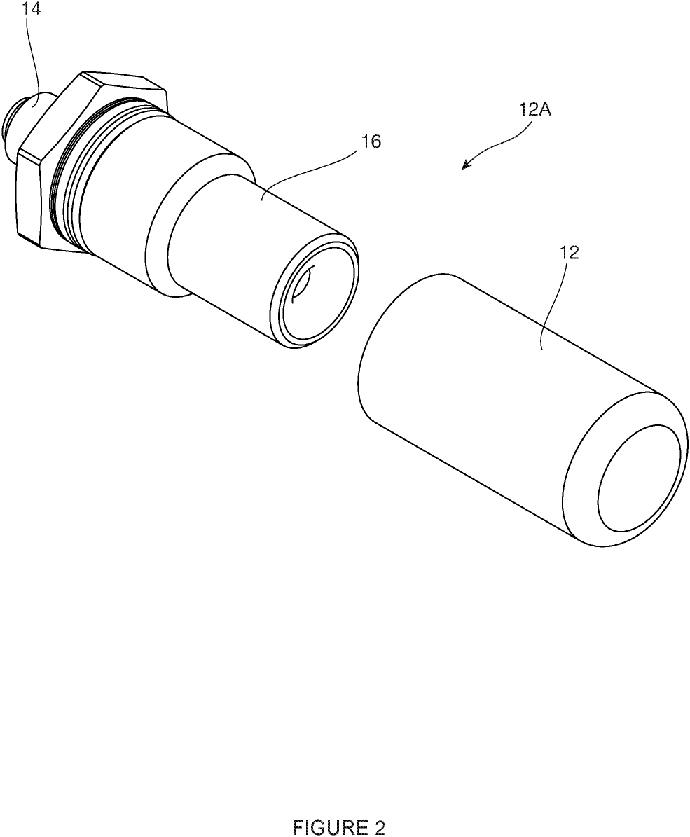

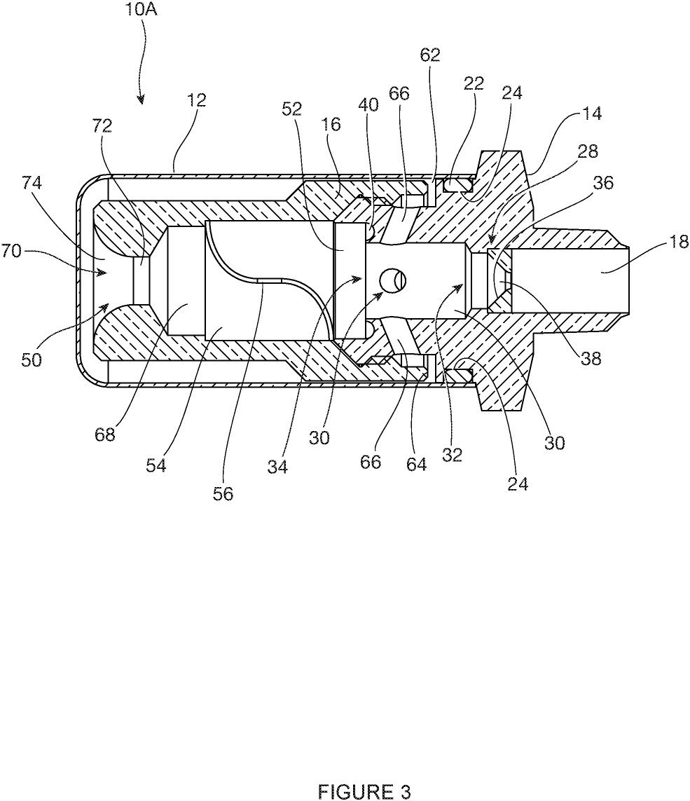

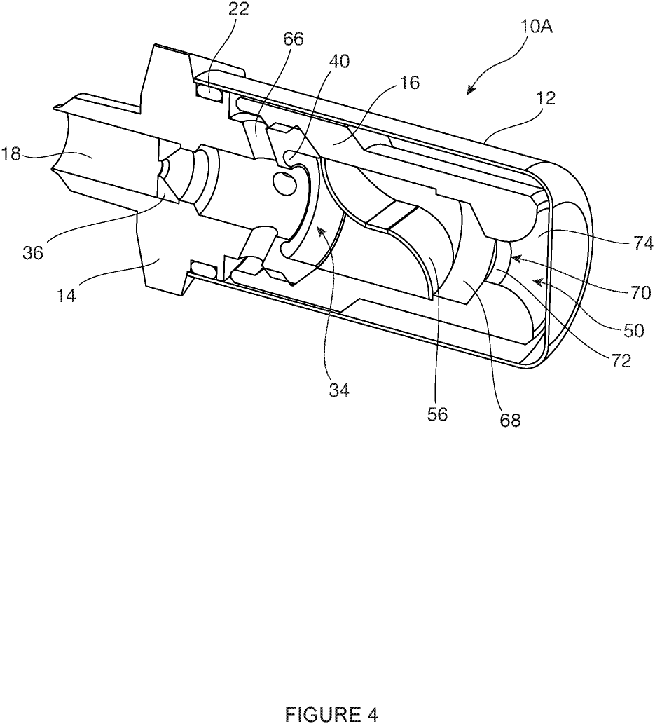

Referring to FIGS. 1 and 4, a first embodiment of an aspirating spray nozzle assembly 10A which has a blow off sheath 12, a nozzle body 14 and a distributor which takes the form of a nozzle cap 16 in this embodiment. Although not explicitly shown in FIGS. 3 and 4, the nozzle body 14 is threadably engaged with the nozzle cap 16 which may be removed for cleaning and maintenance purposes. The nozzle body 1 provides a liquid (first) inlet 18 upstream and an enlarged portion 20 which facilitates connection to supply pipework during installation. The enlarged portion 20 is in the form of a hexagonal ring with a dominant diameter designed to be engaged by an installation tool. The blow off sheath 12 functions as a releasable protection cap which is removably attached to the cylindrical body of the nozzle body 14 and retained in place by a retention means in the form of an O-ring 22 received within a retention groove 24 provided radially about the nozzle body 14, downstream from and adjacent to the enlarged portion 20. The blow off sheath 12 is designed to be come off automatically once it is thrusted by the force of the liquid jet. The blow off sheath 12 is also designed to encapsulate and protect both the discharge outlet 50 and the aspirating air inlets 66 from build-up of dirt, debris and contaminants that might lead to blockage and malfunctioning of the nozzle assembly 10A.

Referring to FIGS. 3 and 4, inlet 18 has a first end 26 which is configured to facilitate supply of a liquid jet and a second end 28. The nozzle body 14 also has a venturi (first) chamber 30 which facilitates diffusion of the liquid jet and generation of a venturi effect for aeration of the formable liquid jet. The venturi chamber 30 has a third end 32 being in communication with the second end 28 of the inlet 18 and a fourth end 34 being in direct or indirect communication with the distributor. As previously mentioned, in the present embodiment, the distributor in the form of the nozzle cap 16, has a means adapted to interfere with the liquid jet. The means may take different forms and will be discussed further below. The nozzle body 14 also has a metering orifice disc 36 which is received within the inlet 18 being at or in close proximity to the second end 28 thereof. It will be appreciated that the metering orifice 5 may be integrated with the nozzle body 14. The orifice disc 34 has dispersing means which is in the form of an opening 38 which is configured to cause the liquid jet to spread in the form of a cone having a defined angle. The nozzle body 14 further includes an annular catchment 40 which encircles the fourth end 34 of the venturi chamber 30. The annular catchment 40 is configured and disposed so as to catch and deflect at least a portion of any liquid splashback sent upstream by the interfering means such that the portion of deflected liquid splashback is redirected downstream again into the distributor. In the present embodiment, the annular catchment 40 is in the form of a groove with a profile which is curved, as best shown in FIGS. 3 and 4. It will however be appreciated that the groove may have a different configuration, so long as it serves the purposes of acting like a reservoir to collect splashback liquid which impinges on the surface of the groove and deflecting it back downstream towards the discharging outlet of the nozzle assembly 10A.

As mentioned above, the function of the orifice disc 36 is to spread the liquid jet coming through the inlet 18. It should be noted that the angle of spread of the turbulent jet may be dictated and varied by one or more of the following: the number of openings 38, the size and configuration of each opening 38, the number of orifice discs and the combination of orifice discs. The included angle of the spread and solid turbulent liquid jet may vary between the range of 15° to 30°.

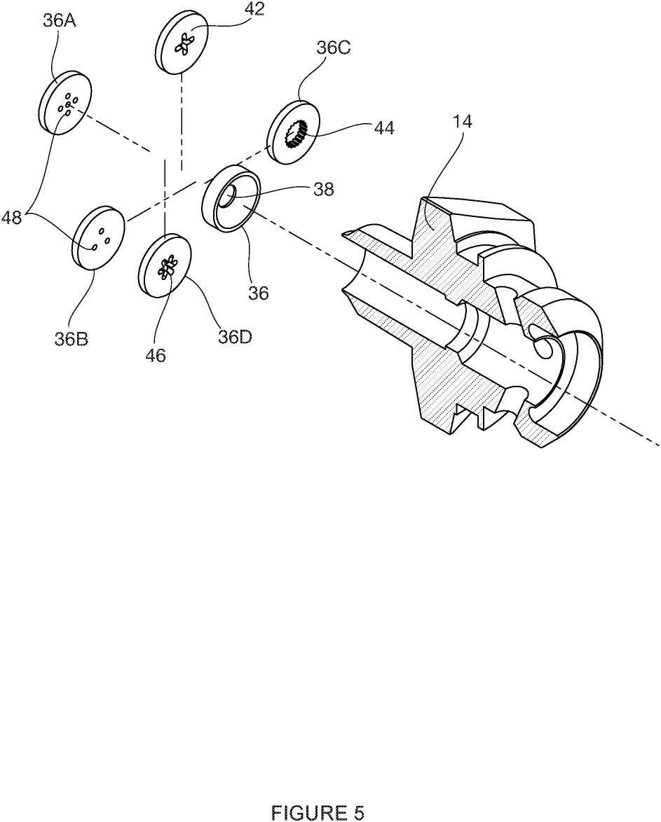

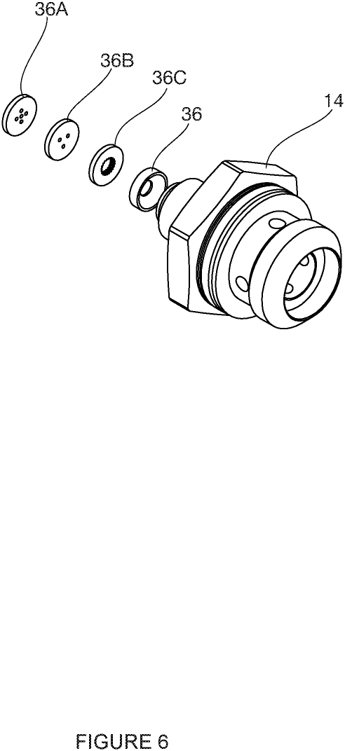

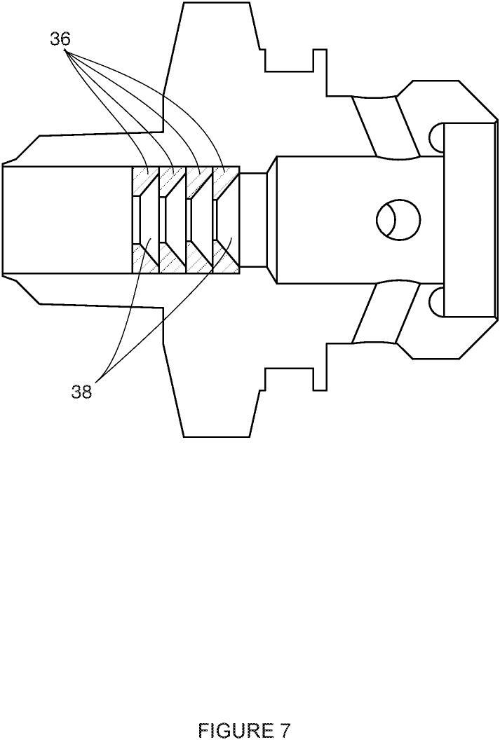

Referring to FIG. 5, in place of the orifice disc 36 with a tapering opening 38, orifice discs with one or more dispersing means in the form of openings may be provided in other sizes and configurations. As alternative embodiments, the orifice disc may have a single opening in the shape of a cross 42, hole with serrations 44 or starfish 46. For instance, the splines of the starfish-shaped opening would engage the liquid jet passing through and add turbulence to the flow. Also, a single orifice disc may include multiple openings in the form of small holes 48 arranged in different patterns, as illustrated in embodiments 36A and 36B. Furthermore, it is contemplated that more than one orifice disc may be provided and stacked together to form a jet stream turbulator. As illustrated in FIG. 6, multiple orifice discs 36, 36A, 36B and 36C are grouped and combined with openings provided in different geometric designs, patterns and configurations so as to spread and add turbulence to the liquid jet. Alternatively, referring to FIG. 7, multiple orifice discs 36 each with the tapering opening 38 are stacked so as to add turbulence. It is contemplated that for the purpose of augmenting turbulence, any orifice disc may be equipped with an internally tapped thread or the like so as to create a rifling effect within its opening. Additionally, it will be appreciated that the opening of orifice disc 36 may have an opening of different sizes. When multiple orifice discs each with a different sized opening are stacked together, the orifices with different sized openings would collectively create a progressively stepped elongate opening thereby generating a stream with extra turbulence.

As best shown in FIGS. 3 and 4, downstream from and adjacent to the enlarged portion 14 is a radial air aspiration annular passage 62 which is formed and defined by a skirt 64 of the nozzle cap 16 and a shoulder of the nozzle body 14 when the nozzle body 14 is threadably mated with the complimentary nozzle cap 16. The nozzle body 14 also has a plurality of aspiration air (second) inlets 66 located around the venturi chamber 30. Each of the inlets 66 has one end in communication with the annular passage 62 and an opposite end in communication with the venturi chamber 30. The inlets 66 are designed to control and vary the air flow into the venturi chamber 30 which air flow is dictated by the predetermined width of the axial opening of the individual inlets 66. In operation, the annular passage 62 facilitates direction of air through the plurality of air inlets 66 into the venturi chamber 30. Such a downstream air flow path opens up into the adjacent rebound chamber 52 with a larger diameter.

Referring back to FIGS. 3 and 4, the nozzle body further includes a rebound (second) chamber 52 which is provided and configured to collect and contain the liquid splashback sent upstream by the interfering means. The rebound chamber 52 with a relatively larger diameter is designed to contain rebounded dispersed jet liquid that impacts the downstream interfering means and redirect the jet liquid downstream again by means of the annular catchment 40 which forms a base around the periphery of the rebound chamber 52. The annular catchment 40 is specifically designed to capture and contain rebound jet liquid and directing it back into the swirl chamber 54 so as to protect the venturi chamber 30 from flooding and malfunctioning due to splashback liquid.

It should be noted that the nozzle body 14 may be assembled to two different types of distributors, namely vortex distributor and baffled distributor, possessing two different types of interfering means respectively.

As shown in FIGS. 3 and 4, the first type of distributor (hereafter referred to as Type 1 distributor) which forms part of the nozzle assembly 10A is in the form of a nozzle cap 16. The nozzle cap 16 has a low resistance swirl (fifth) chamber 54 equipped with a low resistance interference swirl vane 56. The swirl 56 is designed to intercept and interfere with the liquid jet in order to further disperse it at the exit downstream as desired. The forms, configurations and proportions of each of the chambers and components are designed to co-operate and complement the venturi effect required, upstream whilst the nozzle assembly 10A remains to be axially compact as a whole. The desired exit Spray pattern is then formed via a specially derived vortex (fourth) chamber 13 which is designed to capture the swirling liquid and cooperate with a complementary low resistance exit orifice 70. Of a machined form, the exit orifice 70 transitions from a straight opening 72 to a trumpet-shaped exit 74 with a varying profile designed to interfere with and disperse the liquid foam into a conical plume. The plume is capable of a full cone distribution with an adjustable included angle which may be achieved by the respective geometry of the straight opening 72 and trumpet-shaped exit 74. It should be noted that the exit orifice 70 needs to include the trumpet-shaped exit 74 in wide-angle dispersions, for example at an included angle of 80 degrees or higher. For narrow-angle dispersions at an included angle of below 80 degrees, just the straight opening 72 or a slightly prolonged version thereof which enables straight exit of the liquid would suffice.

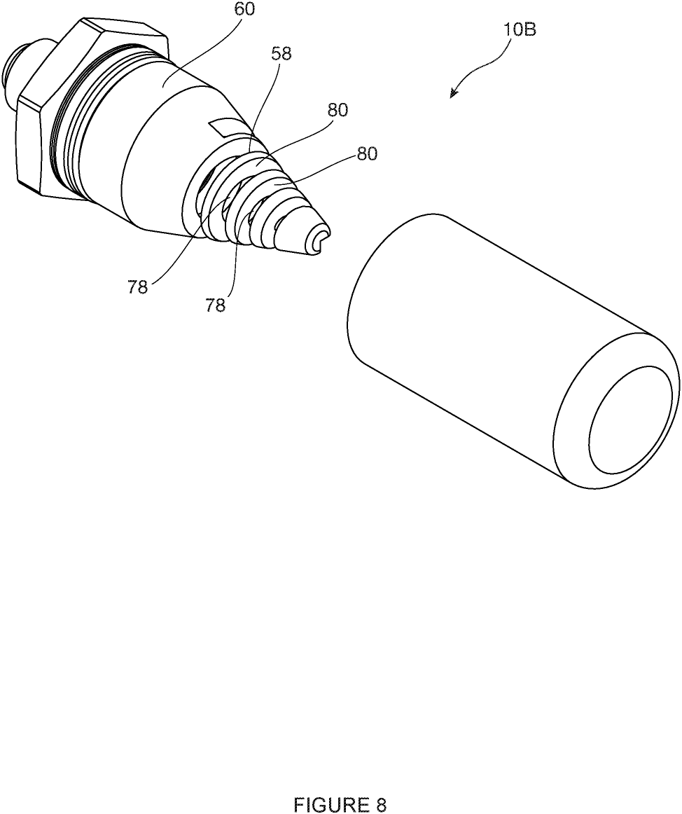

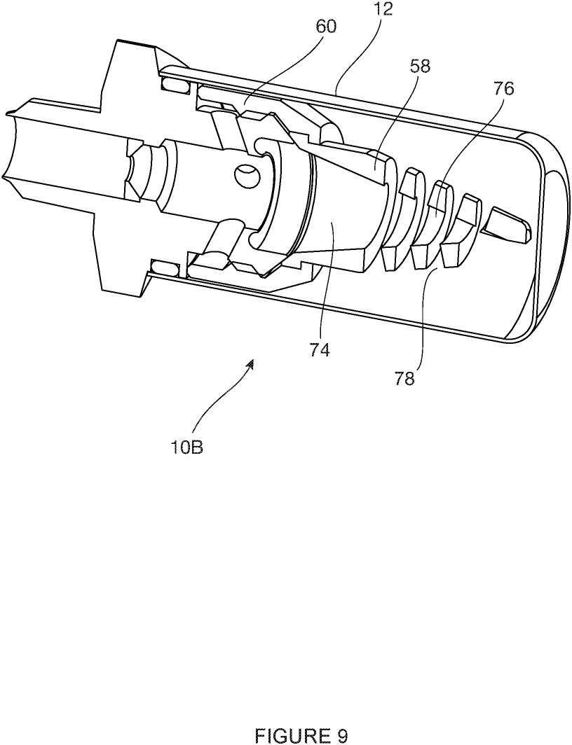

Referring to FIGS. 8 to 10, the second type of distributor (hereafter referred to as Type 2 distributor) which forms part of the nozzle assembly 10B includes a spray head 58 and an adaptor coupling 60 having one end threadably connected to the spray head 58 and another end threadably connected to the spray body 14. It should be noted that optionally, the spray head 58 and adaptor coupling 60 may be integrated with one another. The spray head 58 has a low resistance pre-baffle (third) chamber 74 provided alongside an internally tapered liquid dispersion baffle chamber 76. The pre-baffled chamber 74 is designed to intercept and interfere with the liquid flow in order to further disperse it at the exit downstream as desired. The baffle chamber 76 has angled dispersion baffles 80 which are provided to facilitate creation of a desired exit spray pattern formed via helical cut or cross cut slots 78. The dispersion baffles 80 are arranged at various angles to interfere with and disperse the liquid foam into a conical plume. The plume is capable of full cone distribution at a predetermined included angle achieved via the configuration and disposition of the slots 78.

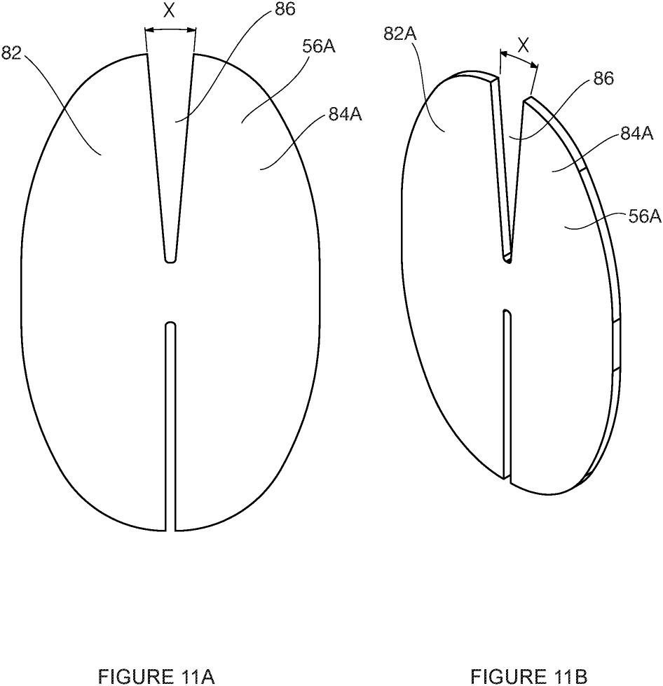

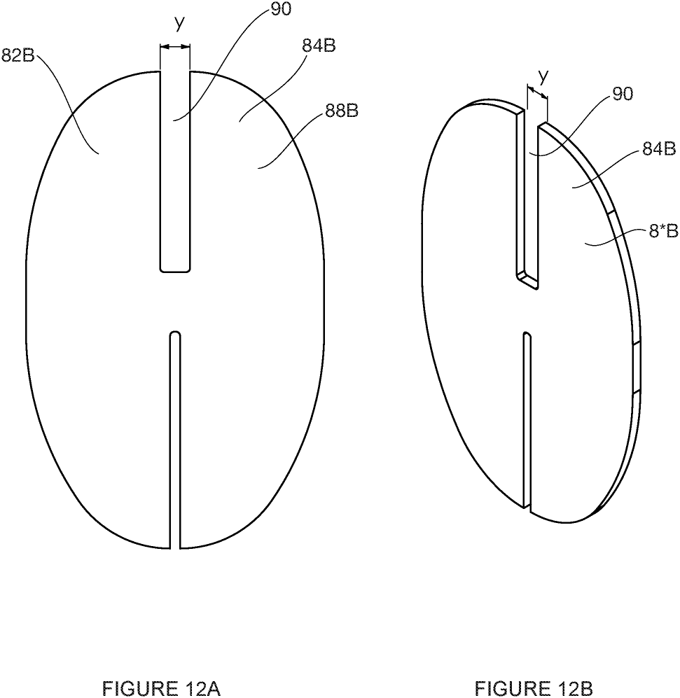

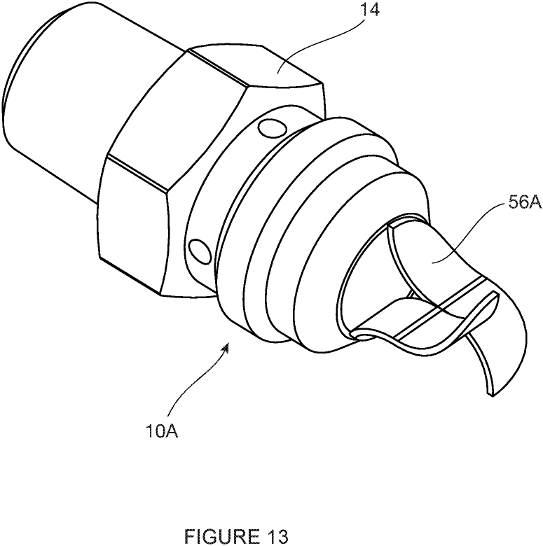

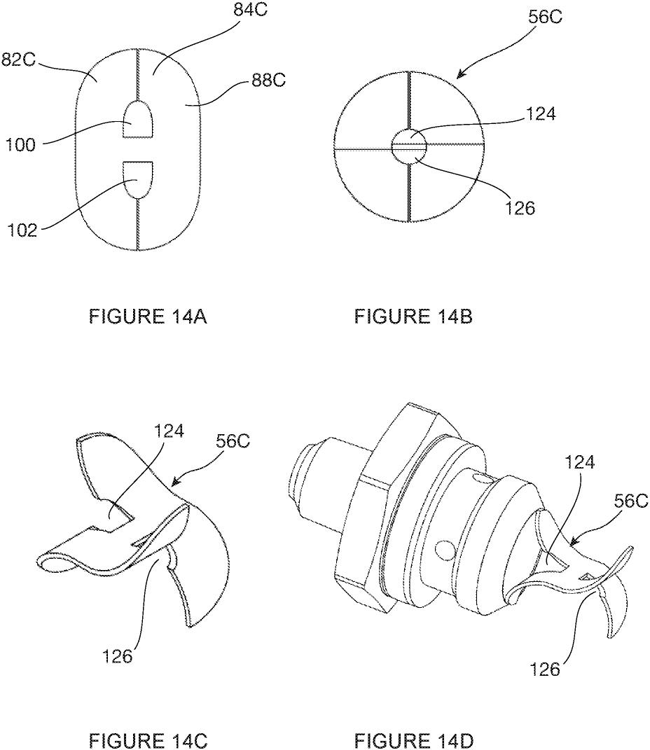

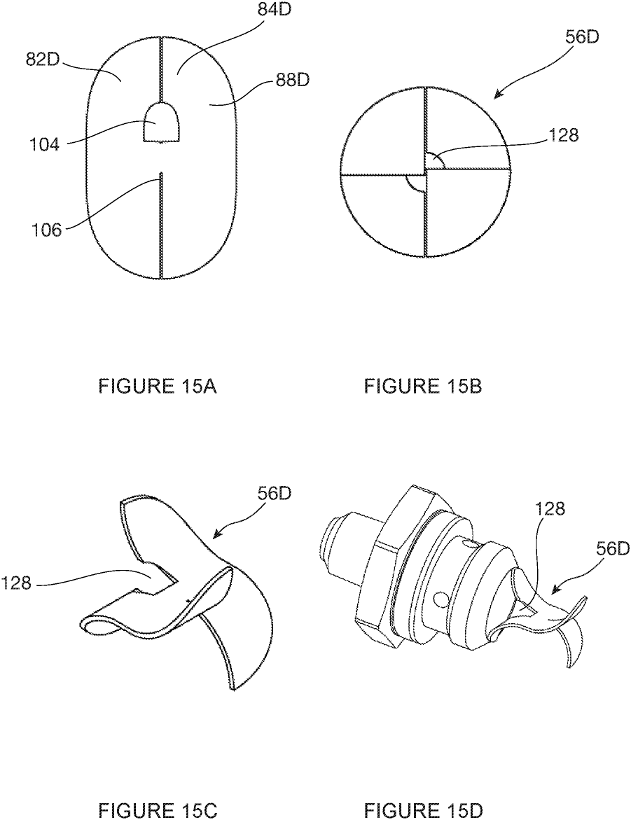

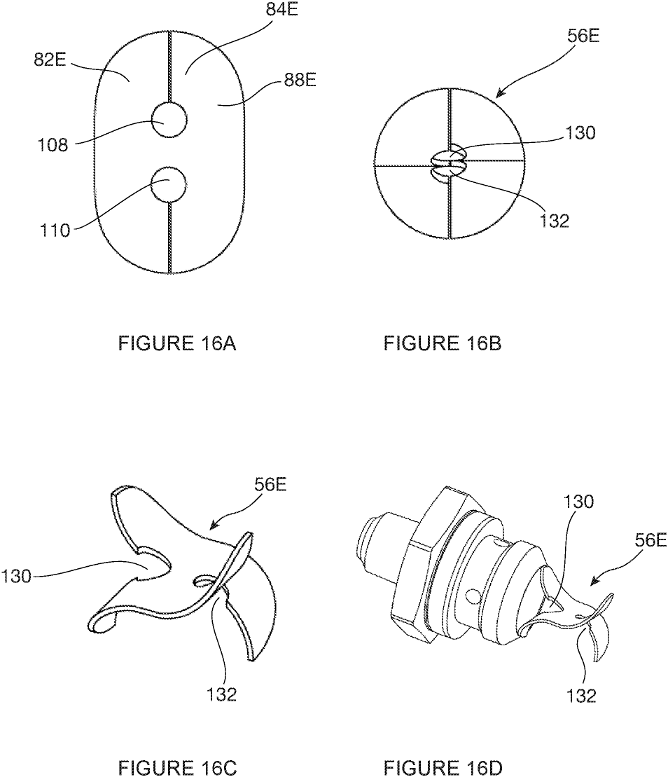

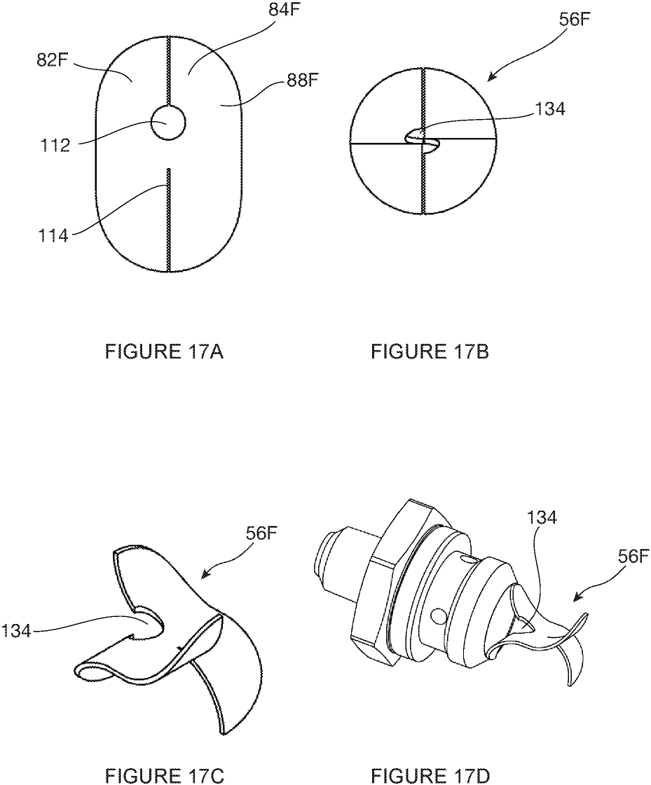

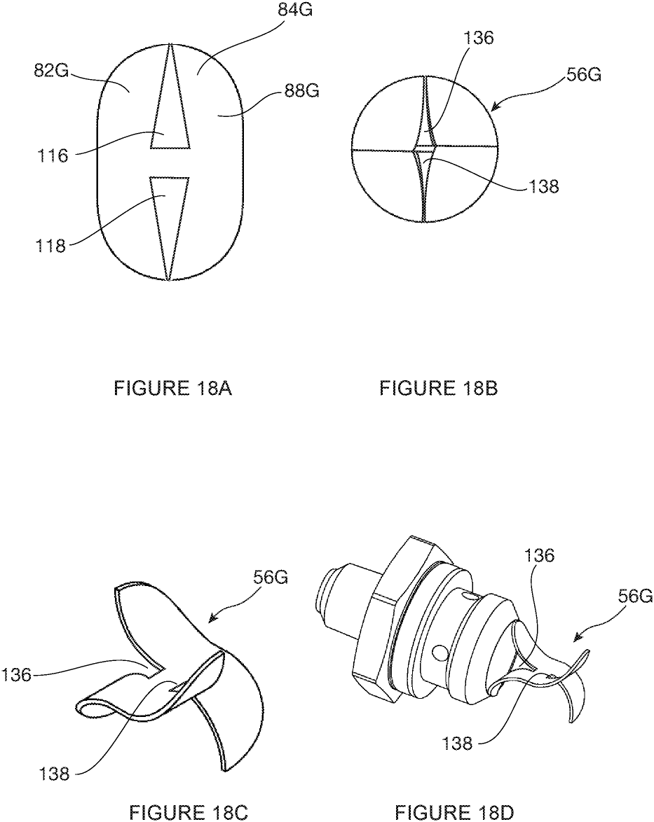

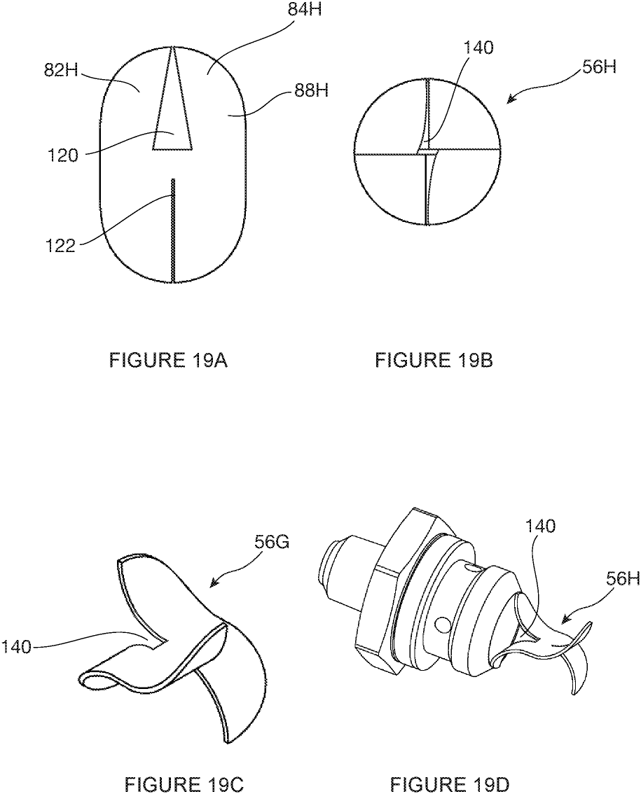

As mentioned above, the swirl 56 is provided in the swirl chamber 54 of the Type 1 distributor. The swirl 56 is mechanically bent formed from a flat laser cut metallic blank, preferably made out of stainless steel, with a nominal thickness of 1 mm. Turning to FIGS. 11A and B, a blank 88A prior to being bent to form its operating shape is shown. The metallic blank 88A is provided with a V-shaped cut-out slot 86 on the downstream side before the wings 82A & 84A are bent to form vanes. As such, in addition to a plume with a substantially hollow cone pattern, the swirl 56A made out of blank 88A is capable of delivering more liquid progressively and centrally to the spray pattern. The cut-out 86 of blank 88A has a central angle X which may vary depending upon the density of the liquid required in the centre the spray plume. For example, the central angle may be enlarged (ie. the cut-out 86 will be larger accordingly) to increase the spray density in the centre of the spray plume. Referring to FIG. 13, the swirl 56A is shown after being bent into the operating form and incorporated into the spray nozzle assembly 10A. Referring to FIGS. 12A and 12B, in an alternative embodiment, the metallic blank 88B, which is to be cut and bent to form a swirl, includes a rectangular slot 90 having a width Y. It is believed that this may also increase the density of the liquid required in the centre of the spray plume. It should be noted that the purpose of providing a cut out in all of the swirls is to ensure that the spray volumetric flux, can be tuned at various portions of the target surface area. In the nozzle art, it is desirable to be able to provide a number of conical nozzle types which are capable of, delivering in different forms and configurations, ranging from a hollow cone to a full cone spray, and everything in between. In some cases, it may be desirable to vary the spray volumetric flux in order to achieve a certain outcome. The provision of different swirl options would facilitate control and adjustment of the spray volumetric flux density of the liquid towards different portions of the target surface in an economical and efficient way. It is contemplated that swirl options may be provided by way of providing an two-dimensional oblong-shaped blank with rounded ends and a cut out of various configurations. The blank is preferred to be joined in the middle with one or two cut-outs created by way of laser cutting. The rounded ends are also severed down the middle so as to create two wings which are to be mechanically bent in a curved fashion to form vanes. Referring to FIGS. 14A to D. 15A to D, 16A to D, 17A to D, 18A to D and 19A to D, oblong-shaped metallic blanks 88C, 88D, 88E, 88F, 88G, 88H with different cut-out 100, 102, 104, 108, 110, 112, 116, 118, 120 and slit 106, 114, 122 configurations and combinations are shown. It is contemplated that once the wings 82A to H & 84A to H are bent up and shaped, the cut-outs 100, 102, 104, 108, 110, 112, 116, 118 & 120 provided in the illustrated different configurations will form a direct axial liquid passage closer to the centre, compared with the V slot or U slot cut-outs previously shown in FIGS. 11 to 13. The cut-outs 100, 102, 104, 108, 110, 112, 116, 118 & 120 are configured so as to facilitate building up of spray density in the centre of the pattern based upon the various cross sectional areas of the respective resulting holes 124, 126, 128, 130, 132, 134, 136, 138 & 140 in the respective swirls 56C, 56D, 56E, 56F, 56G & 56H after forming of the vanes by bending of the wings 82A to H & 84A to H.

During operation, the orifice disc 36 functions to produce a special “narrow spread” of liquid jet with a predetermined included angle. The spread liquid jet travels the length of the venturi chamber 30 and ultimately intercepts with the perimeter of the swirl chamber 54 of Type 1 distributor or baffle chamber 76 of Type 2 distributor. As such, the liquid jet is dispersed in such a way that the spread is evenly distributed across the swirl chamber 54 or baffle chamber 76 before being discharged downstream through the outlet 50 or the disperse slots 78.

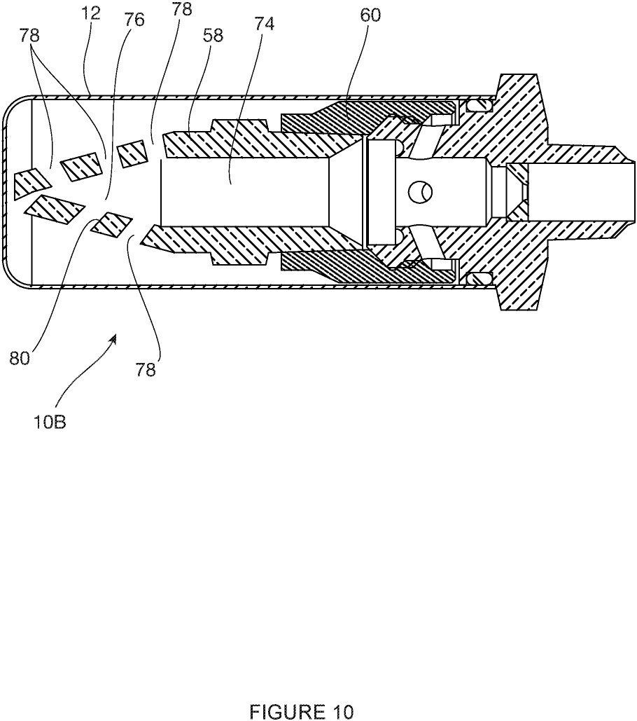

Now that preferred embodiments of the present invention have been described in some detail, it will be appreciated that a major aspect of the present invention, as applied in or to the specific type of aspirating spray nozzle for generation of a “full conical” spray pattern, relates to the handling and disposal of the internal bounce back liquid within the nozzle body 14 and distributor as a result of the resistance encountered by the spread liquid jet or flow in the full cone nozzle described above causing liquid deflection back upstream to enter and flood the upstream venturi chamber 30. The present invention seeks to prevent or at least substantially reduce bounce back liquid due to flow resistance encountered in the exit end of the full cone nozzle of both the Type 1 (Vortex) and Type 2 (Baffled) Distributor. The prevention or reduction is mainly achieved by the provision of a liquid redirection annular catchment 40 that is defined by a diametric groove that is designed to capture liquid moving back upstream at the outer peripheries of the rebound chamber 52 and curve the splashback liquid back downstream to join the bulk of the supply liquid in moving downstream along the defined mainstream central jet. As best shown in FIGS. 3 and 10, the bulk of the supply liquid enters the internal chambers of the nozzle assembly 10A & 10B in and along the centre axis. Also, the downstream flow is at its highest density and velocity towards the centre of various chambers. As such, having encountered the flow resistance or obstructions created by the interfering means, any bounce back liquid is caused to deviate and move away from the bulk of the central downstream flow, getting deflected to travel backwards being guided by the outer periphery of the swirl or pre-baffle and/or rebound chambers. As the bounce back liquid flows back upstream along the outer surfaces of the chambers, it directly engages and impinges on the annular catchment 40 which is complementary to the outer diameter of the rebound chamber 52, thereby resulting in the bounce back liquid being captured and directed into the bulk downstream flow. As such, the likelihood of any bounce back liquid freely entering and flooding the venturi chamber 30 and its outlets and ports is minimized. It will be apparent to a skilled person in the art that the aspirating nozzle assembly of the present invention may offer at least the following advantages:
1. it is capable of generating a short range full conical spray plume;
2. it is able to generate a dispersed jet with by a short length nozzle assembly;
3. it is able to increased density of liquid in the centre of the spray plume;
4. it enables use of the nozzle body to be used with different types of distributors thereby allowing retrofitting and recycling;
5. it is capable of protecting air aspiration holes from contaminant build-ups; and
6. it effectively prevents or at least minimises the likelihood of malfunctioning of the venturi chamber.

Those skilled in the art will appreciate that the present invention is designed to improve the foaming performance by means of improved aeration and dynamic mixing of the air/liquid mix. The present invention is capable of enabling air to be aspirated (ie. drawn in) internally via the creation of a negative pressure zone within the venturi chamber 30. The provision and design of the rebound chamber 52 and/or annular catchment 40 which are located upstream of the swirling chamber or dispersion baffles prevents them from being impediments to the creation of a negative pressure zone. Also, the provision of the one or more orifice discs enables wider dispersions of foam over a shorter distance. In the present invention, the venturi chamber, swirl chamber or dispersion baffles and exit orifice are complementary to one another in assisting aeration. As a result, the nozzle assembly of the present invention is able to convert a metered jet of liquid into a well distributed spread of liquid through the swirling chamber. As such, the spread of liquid is pre-aerated and dispersed through the discharge outlet 50 in a wide conical pattern. Furthermore, the shape and configuration of the blank which is to be transformed into a swirl and the cut out provided therein may vary to achieve desired results.

Those skilled in the art will also appreciate that the invention described herein is susceptible to variations and modifications other than those specifically described. All such variations and modifications are to be considered within the scope and spirit of the present invention the nature of which is to be determined from the foregoing description.

1. An aspirating spray nozzle assembly including a nozzle body and a distributor which are removably attached to one another; the nozzle body including:
a first inlet having a first end adapted to facilitate supply of a liquid jet and a second end;
a first chamber adapted to facilitate diffusion of the liquid jet and generation of a venturi effect, the first chamber having a third end being in communication with the second end of the first inlet and a fourth end being in directly or indirect communication with the distributor which includes a means adapted to interfere with the liquid jet;
one or more orifice discs received within the first inlet being at or in close proximity to a second end, each of the one or more orifice disc(s) having one or more dispersing means adapted to cause the liquid jet to spread in the form of a cone having a defined angle; and
an annular catchment adapted to encircle the fourth end of the first chamber;
wherein the annular catchment is configured and disposed so as to catch and deflect at least a portion of any liquid splashback sent upstream by the interfering means such that the portion of deflected liquid splashback is redirected downstream again into the distributor.

2. The aspiring spray nozzle assembly of claim 1, wherein the angle of spread of the turbulent jet is dictated and varied by one or more of the following: the configuration of the dispersing means, the number of the dispersing means, the number of orifice discs and the combination of orifice discs.

3. The aspiring spray nozzle assembly of claim 1, wherein the liquid jet included angle varies between the range of 15° to 30°.

4. The aspiring spray nozzle assembly of claim 1, wherein a plurality of orifice discs is used to form a jet stream turbulator.

5. The aspiring spray nozzle assembly of claim 4, wherein the orifice discs are combined, grouped and/or stepped.

6. The aspiring spray nozzle assembly of claim 1, wherein the one or more dispersing means include one or more openings provided in different geometric designs, patterns and/or configurations.

7. The aspiring spray nozzle assembly of claim 1, wherein one of the orifice discs with a forwardly flaring opening is splined with another one of the orifice discs with a star-shaped polygonal opening so as to add turbulence to an already spread liquid jet.

8. The aspiring spray nozzle assembly of claim 6, wherein each of the one or more openings includes an internal tapered thread or the like so as to generate a rifling effect thereby enhancing the turbulence.

9. The aspiring spray nozzle assembly of claim 8, wherein the orifice disc is a laser cut sandwich disc.

10. The aspiring spray nozzle assembly of claim 1, wherein the annular catchment is in the form of a groove.

11. The aspiring spray nozzle assembly of claim 10, wherein the groove includes a profile which is curved or take other shapes.

12. The aspiring spray nozzle assembly of claim 1, wherein the nozzle body also includes a second chamber adapted to collect and contain the liquid splashback sent upstream by the interfering means.

13. The aspiring spray nozzle assembly of claim 1, wherein the distributor includes a vortex distributor which includes a swirl or a baffled distributor which includes dispersion baffles.

14. The aspiring spray nozzle assembly of claim 13, wherein the swirl is formed with a blank.

15. The aspiring spray nozzle assembly of claim 14, wherein the blank is oblong-shaped with rounded ends and a cut-out.

16. The aspiring spray nozzle assembly of claim 15, wherein the cut-out is V-shaped flanked by two wings.

17. The aspiring spray nozzle assembly of claim 16, wherein the cut-out slot is located on the downstream side.

18. The aspiring spray nozzle assembly of claim 15, wherein the blank includes a rectangular cut-out.

19. The aspiring spray nozzle assembly of claim 14, wherein the blank has two cutouts.
